(19) United States
(12) Patent Application Publication
(10) Pub. No.: US 2013/0167732 A1
(43) Pub. Date: Jul. 4, 2013

(54) Brewing Device

(71) Applicant: Kim Vibe Petersen, Kokkedal (DK)

(72) Inventor: Kim Vibe Petersen, Kokkedal (DK)

(73) Assignee: SCANOMAT A/S, Kokkedal (DK)

(21) Appl. No.: 13/821,561

(22) PCT Filed: Sep. 7, 2011
(86) PCT No.: PCT/DK11/00100

§ 371 Date: Mar. 22, 2013

(30) Foreign Application Priority Data
Sep. 8, 2010 (DK) PA 2010 00798

(51) Int. Cl. A47J 31/46; B08B 9/027

(52) U.S. Cl. CPC A47J 31/46; B08B 9/027
USPC 99/294; 99/300; 134/22.12

(57) ABSTRACT

When, according to the invention, various hot and cold beverages are made from ingredients in a preparation part (1), the dispensing may take place via an outlet pipe (4) with an outlet head (5), to which the beverage ingredients are supplied, and where they are mixed immediately before or at the same time as the beverages are dispensed. This ensures a high quality, as the dispensed beverages will be fleshly produced with the best possible flavour. The supply channels (16, 16a, 16b) for milk are flushed with water after each dispensing for hygienic reasons.

### TECHNICAL FIELD

The invention relates to a brewing device for the making of various hot and cold beverages from beverage ingredients in a preparation part, and wherein the ingredients are supplied to one or more outlet pipes, each provided with an outlet head, to which the various beverage ingredients are supplied via channel connections, so that the individual beverages may be mixed in the outlet head.

### BACKGROUND

Known devices of this type comprise a brewing device, where the preparation and the dispensing take place directly from the device itself. Therefore, the device comprises all functions gathered in the device itself.

Since stores, hot water containers as well as milk foamer and dispensing pipe are included in direct association therewith, such a device will take up a good deal of space.

This complete function of the device means that it must be arranged in association with the dispensing point.

In addition to taking up space, this device causes both noise, smell and vapour to be directly accessible to the surroundings. To this should be added that the operation, such as filling of raw materials, must take place directly on the device in the immediate vicinity of the surroundings.

It is known from the description of WO 02/01993 A1 to separate the preparation part from the dispensing part.

This allows the preparation part to be arranged at a distance from the dispensing part, e.g. in a cabinet or a counter, while the dispensing part may be arranged above it.

This known device is provided with a water-based circulation system, which is capable of supplying hot water to the desired number of outlet points via one or more valves. The drawbacks of this are that it requires a circulating water system and that several outlet points have to be established. As a result, the device is complicated to build, consumes much energy and also takes up much space.

Where milk foam is desired as an ingredient, it is necessary to mount a unit for the making thereof. EP 2 208 452 A1 discloses such a unit for the making of milk foam in a coffee dispenser. The unit comprises a chamber to which vapour and air as well as milk are supplied from a container. These parts are supplied to a foaming chamber, from which the milk foam may be discharged through outlet pipes. If such a unit is to be mounted on a brewing device, it will require much space, and it will not be readily suitable for incorporation in an outlet head.

From EP 1 561 407A1, a brewing device is known, where milk through pressure-pumping is led to a mixing chamber 13 along with steam via outlet pipes 11 and 21. With short intervals the outlet pipes as well as the mixing chamber will be flushed with cold water and/or steam for the cleansing of these.

This flushing requires a relatively large amount of flushing ingredient, which is why it must be regarded as necessary waste, which is not usable in the beverages. In addition, the milk admission, which happens through pumping-pressure and therefore requires a pump which is complicated to clean, is adequate.

A similar brewing device is known from EP 2 189 085A1. This device too entails an outlet head 2 with a mixing chamber 28, to which milk is led through pumping-pressure, as well as steam mixed with air 16. Cleansing of the parts, in which the milk runs in this device, is done by replacing the outlet head 2 and the admission hose 26 with new clean units. It would be difficult and complicated to have the unit developed into becoming an integrated part of the outlet head itself.

### SUMMARY OF THE INVENTION

It is the object of the invention to remedy these defects and drawbacks of known devices, and this is achieved according to the invention in that the ingredient milk foam is formed by supplying cold milk to a mixing chamber provided in the outlet head via a channel connection from a milk container, and that water vapour with or without air under pressure is supplied to the mixing chamber where the milk foam is formed and discharged via an outlet opening in the outlet head.

This provides for a compact and easy-to-clean structure, where all supply lines extend inside the outlet head itself, and where the mixing of the selected ingredients takes place in the outlet head itself. Thus, when the mixing is allowed to take place in the outlet head itself, a high degree of hygiene and simultaneously a completely uniform mixing are achieved, without any risk of that various types of beverages are mixed together and thereby disturb the taste.

The invention provides the possibility of dispensing cold as well as hot beverages, just as it is possible to supply ingredients such as cream, whipped cream, carbonated water and various types of juices, so-called soft drinks.

When the vapour is supplied via a Venturi nozzle inside the outlet head, the milk will be sucked into the mixing chamber, thereby avoiding the need for pumping power.

When embodying both the outlet pipe and the outlet head with the same external diameter, and by letting all the supply channels run inside the pipe, the outlet can take place via a bent outlet pipe which extends above e.g. a counter top.

Finally, it is expedient to use a method of cleaning the individual supply channels for milk and other ingredients, comprising flushing with cold water after each use. Since the flushing-water consists of a relatively small amount, it can easily be added to the beverage, and the water will not go to waste.

### BRIEF DESCRIPTION OF THE DRAWINGS

An example of a device according to the invention will be explained below with reference to the drawing, in which

FIG. 1 shows an example of the incorporation of the preparation part, the brewing part, in a floor cupboard and with outlet pipe and outlet head protruding from the tabletop,

FIG. 2 shows an exploded, perspective view of an outlet head with the individual components,

FIG. 3 shows the outlet head, seen toward the outlet openings,

FIG. 4 shows a sectional view through the outlet head, seen in the direction IV-IV in FIG. 3, and

FIG. 5 shows a sectional view through the outlet head, seen in the direction V-V in FIG. 3.

### DETAILED DESCRIPTION OF THE INVENTION

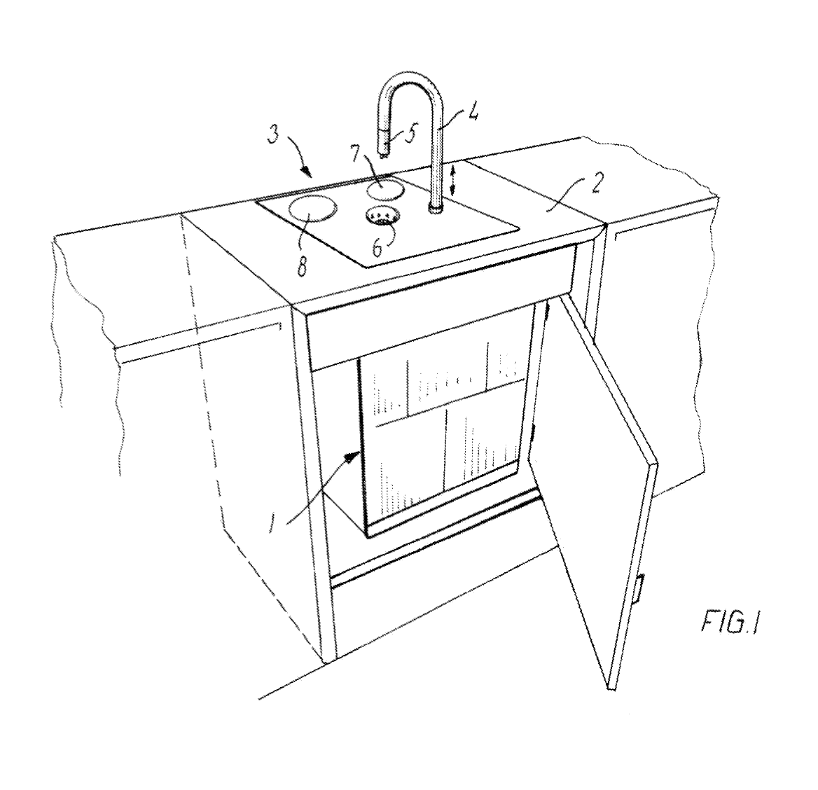

FIG. 1 shows an example of an installation, where the preparation part 1 itself is built into a cupboard or a counter.

In the example shown, the tabletop 2, which extends above the preparation part 1, is provided with a special plate, in which a drain 6 and two covers are shown, through which coffee beans 8 and fresh milk 7, respectively, may be filled.

Moreover, there is mounted an outlet pipe 4, which is provided with an outlet head 5 which terminates above the drain 6.

It is indicated by an arrow that the pipe 4 may be raised and lowered, just as it may optionally be pivoted.

Pipes or hoses (not shown) are provided inside the pipe 4 and the housing 5, said pipes or hoses (not shown) conveying the selected beverage ingredients from the preparation part 1 and through the outlet head 5, from which they may run down into cups or glasses (not shown).

In a generally known manner, the preparation part 1 itself contains the necessary stores for the various beverages, ingredients, which are used, as well as a water heater, a vapour boiler, just as a coffee grinder and various pumps for the feeding of the individual beverages are present.

The operation of the preparation part 1 takes place spaced from the dispensing point, which is more practical and also ensures a good hygiene.

Finally, the incorporated brewing part is concealed, and noise as well as vapour release will be reduced significantly.

Of course, it will be possible to establish more outlet pipes and outlet heads so that dispensing may be achieved from several dispensing points.

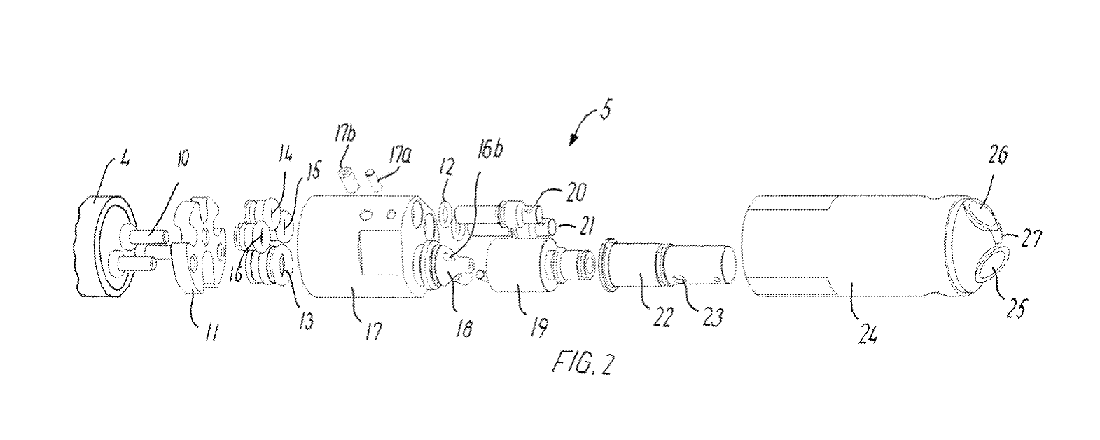

Now, the dispensing head itself will be described with reference to FIGS. 2-5.

FIG. 2 shows the individual parts in a separated state. The outlet pipe 4 is shown furthest to the left in the drawing. The individual pipe connections are not shown, but it will appear from the following that there are supply pipes for vapour, coffee, milk and the like.

The outlet head 5 itself comprises a locking plate 11 with recesses, through which the four pipe connections 10 may extend inside the housing via pipe couplings 13-16.

The pipe couplings are disposed inside a coupling member 17.

Channels for each of the four pipe connections extend in the coupling member 17, and two outlet stubs 20 and 21 and a nozzle 18 are connected with these.

A guide pin 17a and a locking screw 17b are used for holding these parts together, which locking screw is screwed into the coupling member 17. Sealing is ensured by means of gasket rings 12.

The one outlet stub 20 is for additional beverages, while the other stub 21 is for coffee.

The nozzle 18 is e.g. configured to provide a Venturi pump with a negative pressure in a nozzle container 19 so that milk, which is supplied through an opening 16b, will be sucked into a mixing chamber 22a in the mixing part 19, in which milk foam will be formed, and from which the milk foam is supplied via outlet openings 23 to an outlet opening 25 at the end of the end member 24.

The end member includes further outlet openings for coffee 27 and a further outlet 26.

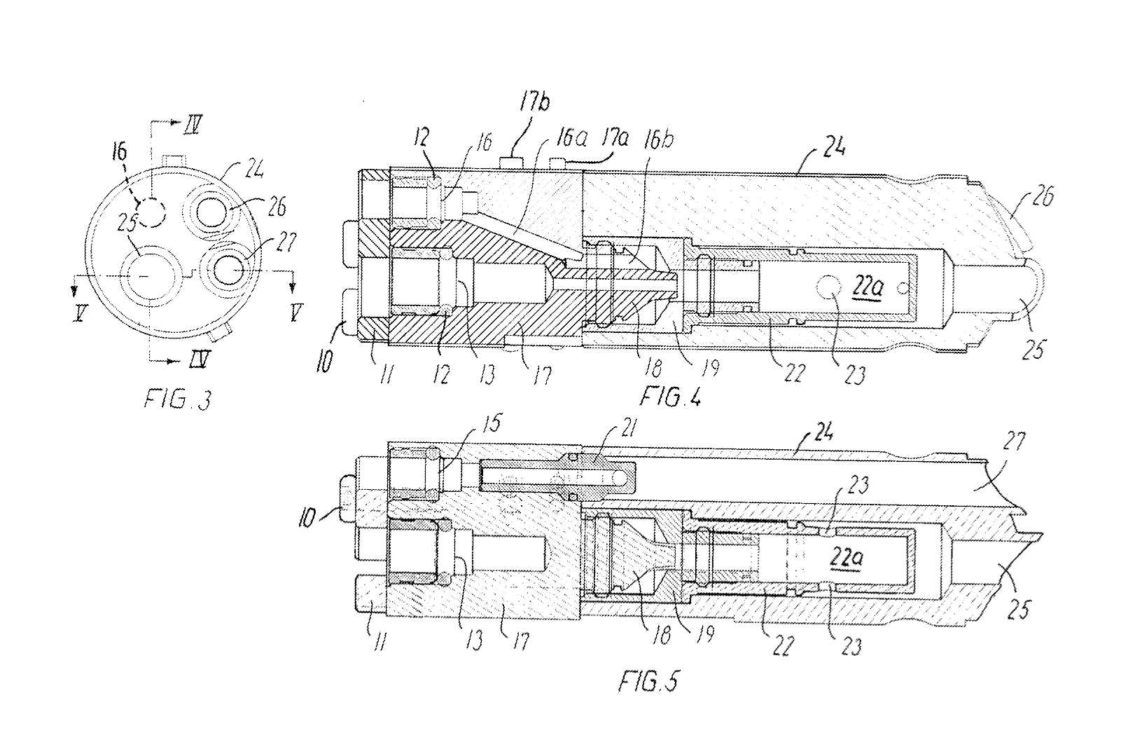

The mode of operation of the outlet housing will now be described with reference to FIGS. 3-5.

FIG. 3 shows the outlet head 5 with outlet openings, where the large opening is for milk foam, the two smaller ones for coffee 27 and a further beverage 24, respectively. The dotted line indicates the pipe connection 16 for fresh milk.

FIGS. 4 and 5 show the assembled outlet head 5, shown in section.

FIG. 4 shows the milk supply from the pipe coupling 16 in an obliquely extending bore 16a to the nozzle 18 via its opening 16b.

Vapour under pressure and admixed with a little air is supplied to the Venturi nozzle 18, which produces a negative pressure which sucks up the milk and is supplied together with the vapour to the mixing chamber 22a in the mixing housing 19, in which the milk is heated and milk foam is formed. This is discharged via openings 23 and is conveyed to the outlet opening 25.

Coffee is fed in pipe connections 15 and 21 and is conveyed via a channel in the end member 24 to the outlet opening 27.

The fact that vapour under pressure and/or hot water are/is conveyed directly to the outlet head 5, provides the possibility of heating as well as mixing with water of beverage concentrates in the outlet head 5 itself. This contributes to ensuring the best beverage quality.

To ensure the necessary hygiene, automatic flushing of the fresh milk from the pipe member is established, just as a little cold flushing water is supplied through the pipe 4 and the head 5 after the dispensing of milk/milk foam.

With respect to the example shown, three openings for coffee, hot water, the like, and milk foam, respectively, have been mentioned. However, it is within the scope of the invention, of course, to establish more pipe connections for further ingredients. Various flavour additives may be supplied through such other channels, just as it is possible to supply various juices and also carbonated cold water.

The essential thing is that mixing and formation of milk foam take place in the outlet head 5 itself, which ensures the best possible quality of the beverages in terms of taste as well as in terms of appearance.

Finally, the device according to the invention may be provided with a remote-controlled control unit so that the operation—i.e. selection of beverages to be dispensed—may take place in a manner which is expedient to the operator.

Since the device is remote-controlled, it may thus be operated at a distance from the brewing device itself.

1. A brewing device for making and dispensing hot and cold beverages, the beverages made by mixing beverage ingredients supplied from a separate preparation part, the device comprising:
one or more separate dispensing points (3) for dispensing the hot and cold beverages into a container, each dispensing point having an outlet pipe (4) provided with an outlet head (5), and wherein the outlet head (5) has a mixing chamber (22a) configured for heating and foaming of milk,
pipes, hoses or channel connections provided inside the outlet pipe (4), each pipe, hose or channel connection delivering an individual beverage ingredient to the mixing chamber (22a) located in the outlet head (5), so that the individual beverage ingredients may be mixed in the mixing chamber (22a) in the outlet head (5) or the individual beverage ingredients may pass therethrough from the preparation part (1) through the outlet head (5), for dispensing into the container.

2. The brewing device according to claim 1, wherein a channel connection (16, 16a, 16b) connects a milk container (7) to the mixing chamber (22a) for delivering milk to the mixing chamber (22a), and wherein discharge openings (23) in the mixing chamber supply water vapour with or without air under pressure, to the mixing chamber (22a), for mixing with the milk delivered therein, forming a milk foam which is discharged through an outlet opening (25) in the outlet head (5).

3. The brewing device according to claim 2, further comprising a nozzle (18) located in the outlet head (5) for supplying the water vapour and to produce a negative pressure for drawing the supply of milk thereto and mixing therewith, the mixture supplied to the mixing chamber (22a).

4. The brewing device according to claim 1 wherein the pipes, hoses or channel connections located in the outlet pipe are configured for dispensing flavour additives, juices and carbonated cold water.

5. The brewing device of claim 1 further comprising a control unit which is adapted for remote control.

6. A method of cleaning the brewing device according to claim 2 comprising:
flushing the supply channels (16, 16a, 16b) and the outlet openings (23, 25) with cold water after each supply of milk or milk foam has passed therethrough.
